(19) United States
(12) Patent Application Publication
(10) Pub. No.: US 2021/0169072 A1
(43) Pub. Date: Jun. 10, 2021

(54) AGROCHEMICAL DISPERSANTS

(71) Applicant: INDORAMA VENTURES OXIDES LLC, The Woodlands, TX (US)

(72) Inventor: Alan J. STERN, The Woodlands, TX (US)

(73) Assignee: Indorama Ventures Oxides LLC, The Woodlands, TX (US)

(21) Appl. No.: 17/045,933

(22) PCT Filed: Jun. 12, 2019
(86) PCT No.: PCT/US2019/036663

§ 371 Date: Oct. 7, 2020

Related U.S. Application Data
(60) Provisional application No. 62/684,885, filed on Jun. 14, 2018.

(51) Int. Cl. A01N 25/10; A01N 43/88; A01N 43/36; A01N 43/707; A01N 43/78; C08F 261/10

(52) U.S. Cl. CPC A01N 25/10; A01N 43/88; C08F 261/10; A01N 43/707; A01N 43/78; A01N 43/36

(57) ABSTRACT

The present disclosure provides a dispersant obtained from the reaction of a styrene maleic anhydride and a monofunctional polyalkylene glycol. The dispersant may be combined with a pesticide and water to form an aqueous agricultural composition.

### CROSS REFERENCE TO RELATED APPLICATIONS

The present application claims priority to U.S. Provisional Patent Application Ser. No. 62/684,885, filed Jun. 14, 2018, the entire contents of which is hereby expressly incorporated herein by reference.

### STATEMENT REGARDING FEDERALLY SPONSORED RESEARCH OR DEVELOPMENT

Not applicable.

### FIELD

The present disclosure generally relates to dispersants for use in various applications, such as in agricultural formulations. In particular, the dispersant of the present disclosure is a product obtained from the reaction of a styrene maleic anhydride copolymer and a monofunctional polyalkylene glycol.

### BACKGROUND

The active ingredients in many agricultural applications are largely hydrophobic or water insoluble in character and are, by necessity, often administered as finely divided solids suspended in aqueous media. The majority of these active ingredients are manufactured and marketed in concentrated form, possibly with the addition of other insoluble inert fillers, which are then diluted prior to application. For example, the active ingredient is typically available in the form of a suspension concentrate (SC), wettable powder (WP) or water dispersible granule (WG). However, due to the generally hydrophobic nature of the active ingredient, the addition of a suitable dispersant is essential in order to achieve a homogenous dispersion with minimum mixing such as may be achieved readily by hand or with minimal mechanical mixing. Furthermore, once a homogenous dispersion is achieved, the resulting suspension must remain stable for a sufficient time, at least, to allow application by usual means such as spraying. Any settling, agglomeration or flocculation of the finely divided solid may lead to inconsistent and ineffective application as well as blockage of the spraying equipment. It is therefore necessary to provide a dispersant which provides a homogenous dispersion and a suspension which maintains its stability during the application of the aqueous dispersion.

Currently used dispersants for SC formulations include ethylene oxide/propylene oxide block copolymer surfactants based on a hydrophobic moiety plus ethylene oxide. Also used are ether phosphate derivatives of non-ionic surfactants, especially of tristyrylphenol ethoxylates. Conventional anionic surfactants used include sulphonated derivatives of arylformaldehyde condensates, polyacrylates and lignosulfonates.

Dispersants for WP and WG formulations are usually limited by the requirements that the dispersant is solid at ambient temperatures, non-gelling and does not dissolve the active principle. For these reasons, conventional non-ionic surfactants are often unsuitable, and anionic dispersants are preferred. Known effective dispersants for WP and WG formulations include sulphonated alkylnaphthalene/formaldehyde condensate salts and lignosulfonate salts.

U.S. Pat. No. 8,247,353 discloses comb polymers which have been found to work well as dispersants in a variety of applications, including in compositions containing water insoluble agrochemical active agents. Such comb polymers may be produced from the reaction of a succinic anhydride-containing resin and an amine.

### SUMMARY

The present disclosure provides a dispersant obtained from the reaction of a styrene maleic anhydride copolymer and a monofunctional polyalkylene glycol of the formula (1):

R¹O—(CₚH₂ₚO)_{z}—[(EO)_{b}-(AO)_{c}]—H (1)

where R¹ is an alkyl group or aromatic group; p is 2 or 3; z is 0, 1, 2, or 3; EO is ethyleneoxy; AO is alkyleneoxy; b is an integer in the range from 0 to 100; c is an integer in the range from 0 to 100; H is hydrogen and where at least one of b or c is greater than zero. In one particular aspect, at least b is greater than zero.

The dispersant of the present disclosure may be used in a variety of applications, such as in aqueous agricultural compositions to disperse agrochemical active ingredients, as well as in pigment, ink or dye formulations to disperse a particulate solid.

### DETAILED DESCRIPTION

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical objects of the article. By way of example, “a monofunctional polyalkylene glycol” means one monofunctional polyalkylene glycol or more than one monofunctional polyalkylene glycol. The phrases “in one aspect”, “according to one aspect” and the like generally mean the particular feature, structure, or characteristic following the phrase is included in at least one embodiment of the present disclosure, and may be included in more than one embodiment of the present disclosure. Importantly, such phrases do not necessarily refer to the same embodiment. If the specification states a component or feature “may”, “can”, “could”, or “might” be included or have a characteristic, that particular component or feature is not required to be included or have the characteristic.

The term “alkyl” as used herein refers to a branched or unbranched saturated hydrocarbon group of 1 to 30 carbon atoms, such as methyl (“Me”), ethyl (“Et”), n-propyl, isopropyl, n-butyl, isobutyl, t-butyl, octyl, decyl, tetradecyl, hexadecyl, eicosyl, tetracosyl and the like. In some aspects, alkyl groups herein contain from 1 to 12 carbon atoms. The term “lower alkyl” refers to an alkyl group of from one to seven carbon atoms, or in some aspects from one to four carbon atoms. The term “higher alkyl” refers to an alkyl group having more than 7 carbon atoms.

The term “alkyleneoxy” refers to a divalent saturated aliphatic hydrocarbyl group bound to oxygen, where the aliphatic hydrocarbyl groups may have from 2 to 5 carbons which are either straight-chained or branched. In one aspect, the alkyleneoxy is selected from propyleneoxy and butyleneoxy.

The term “cycloalkyl” refers to a saturated cyclic alkyl group having 3 to 12 carbon atoms, such as cyclopropyl, cyclohexyl and cyclooctyl which may have suitable substituents on the ring.

The term “alicyclic alkyl” refers to a saturated or unsaturated mono-, bi- or tricyclic ring system, with each cyclic ring consisting of 3 to 10 carbon atoms and optionally having suitable substituents on the ring.

The term “aromatic” refers to a planar cyclic hydrocarbon moiety of conjugated double bonds, which may be a single ring or include multiple fused or covalently linked rings, for example, 2, 3 or 4 fused rings. The term aromatic also includes alkylaryl.

The term “optional” or “optionally” means that the subsequently described event or circumstance may or may not occur, and that the description includes instances where said event or circumstance occurs and instances where it does not. For example, the phrase “optionally substituted alkyl” means that the alkyl group may or may not be substituted and that the description includes both unsubstituted alkyl and alkyl where there is substitution.

The term “Ostwald ripening” refers to coarsening of a precipitate or solid particle dispersed in a medium and is the final stage of phase separation in a solution, during which the larger particles of the precipitate or the solid particle grow at the expense of the smaller particles, which disappear.

The term “suspension concentrate composition” or “SC” and derivative terms refer to compositions comprising finely divided solid particles of an active ingredient, for e.g. a pesticide, dispersed in a fluid medium, for e.g. water. Said particles retain identity and may be physically separated from the fluid medium.

The term “wettable powder” or “WP” is intended to refer to a formulation consisting of an active ingredient (for e.g. a pesticide) in a finely ground state combined with different adjuvants (e.g., wetting agents, stabilizing agents) and bulking agents. A dispersant may be used to facilitate the dispersion of wettable powders into a fluid medium, for e.g. water.

The term “water-dispersible granule” refers to an active ingredient-containing formulation, for e.g. an agricultural pesticide formulation, that is in a granular phase and may be used after being diluted with a fluid medium, for e.g. water. A dispersant may be used to facilitate the dispersion of water-dispersible granules into the fluid medium.

The term “pesticide” refers to at least one pesticide selected from the group consisting of a fungicide, insecticide, nematicide, herbicide, a safener, a plant growth regulator and a mixture thereof. In one particular aspect, the pesticide is selected from the group consisting of a fungicide, an insecticide, a herbicide and a mixture thereof. The person skilled in the art is familiar with such pesticides, which can be found in, for example, the Pesticide Manual, 15th Ed. (2011), The British Crop Protection Council, London.

“Fungicide” means an active ingredient that kills, controls or otherwise adversely modifies the growth of fungal pathogen. Examples of fungicides that can be employed in the present disclosure include, but are not limited to: (3-ethoxypropyl)-mercury bromide, 2-methoxyethylmercury chloride, 2-phenylphenol, 8-hydroxyquinoline sulfate, 8-phenylmercurioxyquinoline, acibenzolar, acibenzolar-S-methyl, acypetacs, acypetacs-copper, acypetacs-zinc, aldimorph, allyl alcohol, ametoctradin, am isulbrom, ampropylfos, anilazine, aureofungin, azaconazole, azithiram, azoxystrobin, barium polysulfide, benalaxyl, benalaxyl-M, benodanil, benomyl, benquinox, bentaluron, benthiavalicarb, benthiavalicarb-isopropyl, benzalkonium chloride, benzamacril, benzamacril-isobutyl, benzamorf, benzohydroxamic acid, bethoxazin, binapacryl, biphenyl, bitertanol, bithionol, bixafen, blasticidin-S, Bordeaux mixture, boscalid, bromuconazole, bupirimate, Burgundy mixture, buthiobate, butylamine, calcium polysulfide, captafol, captan, carbamorph, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, climbazole, clotrimazole, copper acetate, copper carbonate, basic, copper hydroxide, copper naphthenate, copper oleate, copper oxychloride, copper silicate, copper sulfate, copper zinc chromate, cresol, cufraneb, cuprobam, cuprous oxide, cyazofamid, cyclafuramid, cycloheximide, cyflufenamid, cymoxanil, cypendazole, cyproconazole, cyprodinil, dazomet, dazomet-sodium, DBCP, debacarb, decafentin, dehydroacetic acid, dichlofluanid, dichlone, dichlorophen, dichlozoline, diclobutrazol, diclocymet, diclomezine, diclomezine-sodium, dicloran, diethofencarb, diethyl pyrocarbonate, difenoconazole, diflumetorim, dimethirimol, dimethomorph, dimoxystrobin, diniconazole, diniconazole-M, dinobuton, dinocap, dinocap-4, dinocap-6, dinocton, dinopenton, dinosulfon, dinoterbon, diphenylamine, dipyrithione, disulfiram, ditalimfos, dithianon, DNOC, DNOC-ammonium, DNOC-potassium, DNOC-sodium, dodemorph, dodemorph acetate, dodemorph benzoate, dodicin, dodicin-sodium, dodine, drazoxolon, edifenphos, epoxiconazole, etaconazole, etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, fentin chloride, fentin hydroxide, ferbam, ferimzone, fluazinam, fludioxonil, flumetover, flumorph, fluopicolide, fluopyram, fluoroimide, fluotrimazole, fluoxastrobin, fluquinconazole, flusilazole, flusulfamide, flutianil, flutolanil, flutriafol, fluxapyroxad, folpet, formaldehyde, fosetyl, fosetyl-aluminium, fuberidazole, furalaxyl, furametpyr, furcarbanil, furconazole, furconazole-cis, furfural, furmecyclox, furophanate, glyodin, griseofulvin, guazatine, halacrinate, hexachlorobenzene, hexachlorobutadiene, hexaconazole, hexylthiofos, hydrargaphen, hymexazol, imazalil, imazalil nitrate, imazalil sulfate, imibenconazole, iminoctadine, iminoctadine triacetate, iminoctadine trialbesilate, iodomethane, ipconazole, iprobenfos, iprodione, iprovalicarb, isoprothiolane, isopyrazam, isotianil, isovaledione, kasugamycin, kresoxim-methyl, mancopper, mancozeb, mandipropamid, maneb, mebenil, mecarbinzid, mepanipyrim, mepronil, meptyldinocap, mercuric chloride, mercuric oxide, mercurous chloride, metalaxyl, metalaxyl-M, metam, metam-ammonium, metam-potassium, metam-sodium, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, myclobutanil, myclozolin, N-(ethylmercury)-p-toluene-sulphonanilide, nabam, natamycin, nitrostyrene, nitrothal-isopropyl, nuarimol, OCH, octhilinone, ofurace, orysastrobin, oxadixyl, oxine-copper, oxpoconazole, oxpoconazole fumarate, oxycarboxin, pefurazoate, penconazole, pencycuron, penflufen, pentachlorophenol, penthiopyrad, phenylmercuriurea, phenylmercury acetate, phenylmercury chloride, phenylmercury derivative of pyrocatechol, phenylmercury nitrate, phenylmercury salicylate, phosdiphen, phthalide, picoxystrobin, piperalin, polycarbamate, polyoxins, polyoxorim, polyoxorim-zinc, potassium azide, potassium polysulfide, potassium thiocyanate, probenazole, prochloraz, procymidone, propamocarb, propamocarb hydrochloride, propiconazole, propineb, proquinazid, prothiocarb, prothiocarb hydrochloride, prothioconazole, pyracarbolid, pyraclostrobin, pyraclostrobin, pyrametostrobin, pyraoxystrobin, pyrazophos, pyribencarb, pyridinitril, pyrifenox, pyrimethanil, pyriofenone, pyroquilon, pyroxychlor, pyroxyfur, quinacetol, quinacetol sulfate, quinazamid, quinconazole, quinoxyfen, quintozene, rabenzazole, salicylanilide, sedaxane, silthiofam, simeconazole, sodium azide, sodium orthophenylphenoxide, sodium pentachlorophenoxide, sodium polysulfide, spiroxamine, streptomycin, sulfur, sultropen, TCMTB, tebuconazole, tebufloquin, tecloftalam, tecnazene, tecoram, tetraconazole, thiabendazole, thiadifluor, thicyofen, thifluzamide, thiochlorfenphim, thiomersal, thiophanate, thiophanate-methyl, thioquinox, thiram, tiadinil, tioxym id, tolclofos-methyl, tolylfluanid, tolylmercury acetate, triadimefon, triadimenol, triamiphos, triarimol, triazbutil, triazoxide, tributyltin oxide, trichlamide, tricyclazole, tridemorph, trifloxystrobin, triflumizole, triforine, triticonazole, uniconazole, uniconazole-P, validamycin, valifenalate, vinclozolin, zarilamid, zinc naphthenate, zineb, ziram, zoxamide and mixtures thereof.

“Insecticide” means an active ingredient that kills, controls or otherwise adversely modifies the growth of insects. Examples of insecticides that can be employed in the present disclosure include, but are not limited to: 1,2-dichloropropane, abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-ecdysone, alpha-endosulfan, amidithion, aminocarb, amiton, amiton oxalate, amitraz, anabasine, athidathion, azadirachtin, azamethiphos, azinphos-ethyl, azinphos-methyl, azothoate, barium hexafluorosilicate, barthrin, bendiocarb, benfuracarb, bensultap, beta-cyfluthrin, beta-cypermethrin, bifenthrin, bioallethrin, bioethanomethrin, biopermethrin, bistrifluoron, borax, boric acid, bromfenvinfos, bromocyclen, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, cartap hydrochloride, chlorantraniliprole, chlorbicyclen, chlordane, chlordecone, chlordimeform, chlordimeform hydrochloride, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chromafenozide, cinerin I, cinerin II, cinerins, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous earth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinex-diclexine, dinoprop, dinosam, dinotefuran, diofenolan, dioxabenzofos, dioxacarb, dioxathion, disulfoton, dithicrofos, d-limonene, DNOC, DNOC-ammonium, DNOC-potassium, DNOC-sodium, doramectin, ecdysterone, emamectin, emamectin benzoate, EMPC, empenthrin, endosulfan, endothion, endrin, EPN, epofenonane, eprinomectin, esdepallothrine, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide, flucofuron, flucycloxuron, flucythrinate, flufenerim, flufenoxuron, flufenprox, fluvalinate, fonofos, formetanate, formetanate hydrochloride, formothion, formparanate, formparanate hydrochloride, fosmethilan, fospirate, fosthietan, fufenozide, furathiocarb, furethrin, gamma-cyhalothrin, gamma-HCH, halfenprox, halofenozide, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isofenphosmethyl, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, meperfluthrin, mephosfolan, mercurous chloride, mesulfenfos, metaflumizone, methacrifos, methamidophos, methidathion, methiocarb, methocrotophos, methomyl, methoprene, methothrin, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, molosultap, monocrotophos, monomehypo, monosultap, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluoron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, prim idophos, profenofos, profluralin, profluthrin, promacyl, promecarb, propaphos, propetamphos, propoxur, prothidathion, prothiofos, prothoate, protrifenbute, pymetrozine, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulcofuron-sodium, sulfluramid, sulfotep, sulfoxaflor, sulfuryl fluoride, sulprofos, tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethylfluthrin, theta-cypermethrin, thiacloprid, thiamethoxam, thicrofos, thiocarboxime, thiocyclam, thiocyclam oxalate, thiodicarb, thiofanox, thiometon, thiosultap, thiosultap-disodium, thiosultap-monosodium, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, zolaprofos and mixtures thereof.

“Herbicide” means an active ingredient that kills, controls or otherwise adversely modifies the growth of plants. Examples of herbicides that can be employed in the present disclosure include, but are not limited to: 4-CPA, 4-CPB, 4-CPP, 2,4-D, 3,4-DA, 2,4-DB, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofluor, benzoylprop, benzthiazuron, bicyclopyrone, bifenox, bilanafos, bispyribac, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chlorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, diallate, dicamba, dichlobenil, dichloralurea, dichlormate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P, fenoxasulfone, fenteracol, fenthiaprop, fentrazamide, fenuron, ferrous sulfate, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, fluoroxypyr, flurtamone, fluthiacet, fomesafen, foramsulfuron, fosamine, furyloxyfen, glufosinate, glufosinate-P, glyphosate, halosafen, halosulfuron, haloxydine, haloxyfop, haloxyfop-P, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, orthodichlorobenzene, orthosulfamuron, oryzalin, oxadiargyl, oxadiazon, oxapyrazon, oxasulfuron, oxaziclomefone, oxyfluorfen, parafluoron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, thidiazimin, thidiazuron, thiencarbazone-methyl, thifensulfuron, thiobencarb, tiocarbazil, tioclorim, topramezone, tralkoxydim, tri-allate, triasulfuron, triaziflam, tribenuron, tricamba, triclopyr, tridiphane, trietazine, trifloxysulfuron, trifluralin, triflusulfuron, trifop, trifopsime, trihydroxytriazine, trimeturon, tripropindan, tritac tritosulfuron, vernolate, xylachlor and mixtures thereof.

“Safener” means an active ingredient applied with herbicides to protect crops against their injury. Some of the safeners that can be employed in the present disclosure include, but are not limited to: benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148, N-phenylsulfonylbenzoic acid amides and mixtures thereof.

“Nematicide” means an active ingredient having an effect on, such as reduction in the damage caused by, agricultural-related nematodes. Examples of nematicides which may be used in the present disclosure include, but are not limited to: an avermectin (e.g., abamectin), carbamate nematicides (e.g., aldicarb, thiadicarb, carbofuran, carbosulfan, oxamyl, aldoxycarb, ethoprop, methomyl, benomyl, alanycarb), organophosphorus nematicides (e.g., phenamiphos (fenamiphos), fensulfothion, terbufos, fosthiazate, dimethoate, phosphocarb, dichlofenthion, isamidofos, fosthietan, isazofos ethoprophos, cadusafos, terbufos, chlorpyrifos, dichlofenthion, heterophos, isamidofos, mecarphon, phorate, thionazin, triazophos, diamidafos, fosthietan, phosphamidon, captan and mixtures thereof.

“Plant growth regulator” means an active ingredient used to influence the growth characteristics of plants. Examples of plant growth regulators which may be used in the present disclosure include, but are not limited to: 1-naphthaleneacetic acid, 1-naphthaleneacetic acid K-salt, 1-napthol, 2,4-dichlorophenoxyacetic acid (2,4-D), 2,4-DB, 2,4-DEP, 2,3,5-triiodobenzoic acid, 2,4,5-trichlorophenoxyacetic acid, 2-naphthoxyacetic acid, 2-naphthoxyacetic acid sodium salt, 3-chloro-4-hydroxyphenylacetic acid, 3-indoleacetic acid, 4-biphenylacetic acid, 4-chlorophenoxyacetic acid (4-CPA), 4-hydroxyphenylacetic acid, 6-benzylaminopurine, Auxindole, α-naphthaleneacetic acid K-salt, β-naphthoxyacetic acid, p-chlorophenoxyacetic acid, dicamba, dichlorprop, fenoprop, indole-3-acetic acid (IAA), indole-3-acetyl-DL-aspartic acid, indole-3-acetyl-DL-tryptophan, indole-3-acetyl-L-alanine, indole-3-acetyl-L-valine, indole-3-butyric acid (IBA), indole-3-butyric acid K-salt, indole-3-propionic acid; α-naphthaleneacetic acid, methyl indole-3-acetate, naphthaleneacetamide, naphthaleneacetic acid (NAA), phenylacetic acid, picloram, potassium naphthenate, sodium naphthenate, 4-hydroxyphenethyl alcohol, 4-CPPU, 6-benzylaminopurine (BA), 6-(Y,Y-dimethylallylamino)purine (2iP), 2-iP-2HCl, adenine, adenine hemisulfate, benzyladenine, kinetin, meta-topolin, N6-benzoyladenine, N-benzyl-9-(2-tetrahydropyranyl) adenine (BP A), N-(2-chloro-4-pyridyl)-N-phenylurea, gibberellic acid (GA3), gibberellins, gibberellins A4+A7 (GA4/7), ethylene and abscisic acid.

The term “target substrate” refers to sites underlying plant foliage which are the intended destination for the pesticide including, but not limited to, natural ground surfaces such as soil, water (lakes, ponds, marshes, swamps, streams, puddles, etc.) and artificial surfaces such as pavement; a pest; or a combination thereof.

A “pest” generally includes insects, mites, ticks and other arthropods; disease agents such as fungi, protozoa, bacteria and viruses; helminths, nematodes (roundworms), cestodes (tapeworms), platyhelminths (flatworms), trematodes (flukes) and other worms; sporozoan parasites; slugs and snails; and vertebrates such as birds, rodents or other vertebrates which can directly or indirectly injure or cause disease or damage in any plant or part thereof or any processed, manufactured or other product of the plant.

A “pesticidally effective amount” refers to that amount of a pesticide which, upon application, either reduces the presence of pests, or enhances a plant's resistance to a pest.

According to one aspect, the present disclosure provides a dispersant obtained from the reaction of a styrene maleic anhydride copolymer and a monofunctional polyalkylene glycol of the formula (1):

R¹O—(CₚH₂ₚO)_{z}—[(EO)_{b}-(AO)_{c}]—H (1)

where R₁ is an alkyl group or aromatic group; p is 2 or 3; z is 0, 1, 2, or 3; EO is ethyleneoxy; AO is alkyleneoxy; b is an integer in the range from 0 to 100; c is an integer in the range from 0 to 100; and H is hydrogen and where at least one of b or c is greater than zero. In one particular aspect, at least b is greater than zero.

Styrene maleic anhydride copolymers are polymers that are formed with styrene and maleic anhydride monomers. For the various aspects, the styrene maleic anhydride copolymer has a first constitutional unit of the formula

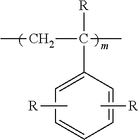

and a second constitutional unit of the formula

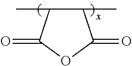

where each m and x is independently a real number that represents a mole fraction of the respective constitutional unit in the styrene maleic anhydride copolymer, and each R is independently a hydrogen, an aryl group or an aliphatic group. As used herein, “constitutional units” refer to the smallest constitutional unit (a group of atoms comprising a part of the essential structure of a macromolecule), or monomer, the repetition of which constitutes a macromolecule, such as a polymer.

For various aspects, the mole fraction m is within a range of from about 0.5 to about 0.9 and the mole fraction x is within a range of from about 0.1 to about 0.5, where (m+x)=1.00. In another aspect, the mole fraction m is within a range of from about 0.8 to about 0.9 and the mole fraction x is within a range of from about 0.1 to about 0.2, where (m+x)=1.00. In aspects of the present disclosure, m and x are each greater than zero. With respect to each R group, examples of the aromatic group include, but are not limited to, phenyl, biphenyl, naphthyl, substituted phenyl or biphenyl, and naphthyl. Examples of the aliphatic group include, but are not limited to, alkyl and alicyclic alkyl.

The styrene maleic anhydride copolymers which may be used in the present disclosure can be selected from one styrene maleic anhydride copolymer or mixtures of styrene maleic anhydride copolymers, and having a styrene to maleic anhydride molar ratio of at least 4.0:1.0, or in other aspects at least 5.0:1.0, while in still other aspects at least 6.0:1.0, and in still further aspects at least 7.0:1.0. In contrast to what is generally taught with respect to state of the art dispersants, Applicant has unexpectedly found that a styrene to maleic anhydride ratio of at least 4.0:1.0 can be critical to the ability of the inventive dispersants to permit agrochemical suspension concentrate compositions to be milled, to minimize the viscosity of concentrated particle suspensions at elevated temperatures while under constant shear, and to reduce or prevent Ostwald ripening of slightly water soluble pesticides.

According to other aspects, the styrene maleic anhydride copolymers which may be used in the present disclosure can be selected from one styrene maleic anhydride copolymer or mixtures of styrene maleic anhydride copolymers, and having a styrene to maleic anhydride molar ratio within a range of from 4.0:1.0 to 8.0:1.0, and in other aspects within a range of from 6.0:1.0 to 8.0:1.0.

According to another aspect, styrene maleic anhydride copolymers which may be used in the present disclosure can be selected from one styrene maleic anhydride copolymer or mixtures of styrene maleic anhydride copolymers, and having a weight average molecular weight (Mw) that is less than 50,000 grams per mole (g/mol), in other aspects less than 20,000 g/mol, and in still more aspects less than 15,000 g/mol. The weight average molecular weight can be determined by gel permeation chromatography (GPC).

According to another aspect, other monomers, besides styrene, may be incorporated into the backbone of the styrene maleic anhydride copolymer. In general, monomers suitable for use are those having a low molecular weight to keep the overall molecular weight of the final polymer relatively low (for e.g., less than 50,000 g/mol) so that it remains relatively water soluble. Possible monomers that may be present, in addition to styrene, include olefins such as ethylene, conjugated dienes such as 1,3-butadiene and isoprene, acrylic acid, alkyl acrylates and methacrylates, especially lower alkyl such as methyl, ethyl and, the butyl and ethylhexyl esters, vinyl acetate, acrylonitrile, methacrylonitrile, acrylamides, methacrylamides, unsaturated ethers such as alkyl vinyl ethers, for instance, the methyl and ethyl ethers, AMPS, alpha-methyl styrene and hydroxyethyl methacrylate.

Commercially available styrene maleic anhydrides which may be used include, but are not limited to, the XIRAN® resins available from Polyscope Polymers, such as XIRAN® EF-40 resin and XIRAN® EF-60 resin.

In the monofunctional polyalkylene glycol of formula (I) which is reacted with the styrene maleic anhydride copolymer, R¹ represents the alkyl or aromatic radical of an alcohol R¹—OH that is employed as a starter alcohol which is reacted (alkoxylated) with an ethylene oxide and/or alkylene oxide to produce the monofunctional polyalkylene glycol of formula (1).

According to one aspect, the starter alcohol R¹OH is a short-chain aliphatic alcohol, and R¹ may represent a lower chain alkyl, such as methyl, ethyl, n-propyl, isopropyl, n-butyl, 2-butyl, isobutyl or tert-butyl, n-pentyl, 1-methylbutyl, 2-methylbutyl, 3-methyl-butyl, 1,1-dimethylpropyl, 1,2-dimethylpropyl, 2,2-dimethylpropyl, 1-ethylpropyl, 2-ethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethyl-butyl, 3,3-dimethylbutyl, 1-ethylbutyl, 2-ethylbutyl, 3-ethylbutyl, 1,1,2-trimethylpropyl, 1,2,2-trimethylpropyl, 1-ethyl-1-methylpropyl, 1-ethyl-2-methylpropyl, 2-ethyl-1-methyl-propyl, 2-ethyl-2-methylpropyl, n-heptyl, 1-methylhexyl, 2-methylhexyl, 3-methylhexyl, 4-methylhexyl, 5-methylhexyl, 1,1-dimethylpentyl, 1,2-dimethylpentyl, 1,3-dimethyl-pentyl, 1,4-dimethylpentyl, 2,2-dimethylpentyl, 2,3-dimethylpentyl, 2,4-dimethylpentyl, 3,3-dimethylpentyl, 3,4-dimethylpentyl, 4,4-dimethylpentyl, 1-ethylpentyl, 2-ethylpentyl, 3-ethylpentyl, 4-ethylpentyl, 1,1,2-trimethylbutyl, 1,1,3-trimethylbutyl, 1,2,2-trimethyl-butyl, 1,2,3-trimethylbutyl, 1,3,3-trimethylbutyl, 1-ethyl-1-methylbutyl, 1-ethyl-2-methyl-butyl, 1-ethyl-3-methylbutyl, 2-ethyl-1-methylbutyl, 2-ethyl-2-methylbutyl, 2-ethyl-3-methylbutyl, 3-ethyl-1-methylbutyl, 3-ethyl-2-methylbutyl, 3-ethyl-3-methyl-butyl, 1-propylbutyl, 2-propylbutyl, 3-propylbutyl, 1-butylpropyl, 2-butylpropyl, 1-propyl-1-methylpropyl, 1-propyl-2-methylpropyl, 2-propyl-1-methylpropyl, 2-propyl-2-methylpropyl, 1,1-diethylpropyl or 1,2-diethylpropyl.

According to still another aspect, the starter alcohol R¹—OH is a cycloaliphatic alcohol or aromatic alcohol and R¹ may represent cyclohexanyl, phenyl, benzyl and cresyl isomers.

According to yet another aspect, the starter alcohol may be a mixture of any of the above starter alcohols (i.e. a mixture of any of a short-chain alcohol, a long-chain alcohol, a cycloaliphatic alcohol and an aromatic alcohol).

The starter alcohol R¹—OH may be straight-chain (linear), branched or cyclic. In the event that it is branched, the main chain of the alcohol moiety, according to a particular aspect, may have, as a rule, 1 to 4 branches. The branches independently of one another may have 1 to 10, or 1 to 6 or even 1 to 4 carbon atoms. Particular branches may include methyl, ethyl, n-propyl or isopropyl groups.

According to one aspect, the starter alcohol R¹—OH may be a linear short-chain alcohol, for example, methanol, ethanol, n-propanol, n-butanol, n-pentanol, n-hexanol or n-heptanol. In still another aspect, the starter alcohol R¹—OH may be an aromatic alcohol, such as phenol, benzyl alcohol or cresyl alcohol.

In one particular aspect, z represents zero in the monofunctional polyalkylene glycol of the formula (I).

In aspects where z represents 1, 2 or 3 in the monofunctional polyalkylene glycol of formula (1), such glycols may be prepared in a targeted fashion by reacting, for example, a starter alcohol of formula (2):

R¹—O—(CₚH₂ₚO)_{q}—H (2)

where R¹, p and z are defined above with an ethylene oxide and/or an alkylene oxide. The compounds of the formula (2) may be, in particular, mono-C1-C7 alkyl ethers of ethylene glycol (p=2; z=1), propylene glycol (p=3; z=1), diethylene glycol (p=2; z=2), dipropylene glycol (p=3; z=2), triethylene glycol (p=2; z=3) or tripropylene glycol (p=3; z=3), which are known per se.

Of particular importance in accordance with one aspect of the present disclosure, the starter alcohol is an alkyl ether of mono-, di- and tripropylene glycol of the formula (2a):

R¹—O—(CH₂CH(CH₃)O)_{z}—H (2a)

where R¹ represents C1-C7 alkyl and z is as defined herein.

Another aspect emphasizes the mono-C1-C4 alkyl ethers (i.e. R¹ represents in particular C1-C4 alkyl), and of these especially the dipropylene glycol monoalkyl ethers (z=2). They include, in particular, dipropylene glycol monomethyl ether, dipropylene glycol monoethyl ether, dipropylene glycol mono-n-propyl ether and dipropylene glycol mono-n-butyl ether.

The alkoxylation is the result of the reaction of the starter alcohol R¹—OH with ethylene oxide (EO) and/or other alkylene oxides (AO), such alkylene oxides having 3 to 6 carbon atoms. The following alkylene oxides may be mentioned in particular in this context: 1,2-propylene oxide (PO), 1,2-butylene oxide (BO), 1,2-pentylene oxide (PeO) and 1,2-hexylene oxide (HO). A particularly preferred alkylene oxide is 1,2-propylene oxide (PO).

The respective degree of alkoxylation is the result of the charged amounts of ethylene oxide and/or other alkylene oxide(s) and the reaction conditions selected for the reaction (alkoxylation). The former is, as a rule, a statistical mean, since the number of ethylene oxide and/or alkylene oxide units of the monofunctional polyalkylene glycols which are the result of the reaction varies.

The degree of alkoxylation, i.e. the mean chain length of the polyether chains of polyalkylene glycols according to the present disclosure, and their composition (in other words, the values of b and c) can be controlled by the ratio of the molar amounts of starter alcohol to EO and/or AO employed in their preparation, and by the reaction conditions. In most aspects, the monofunctional polyalkylene glycol of formula (1) may have at least approximately 2, or at least approximately 4, in particular at least approximately 5, especially at least approximately 6, 7 or 8 and particularly preferably at least approximately EO and AO units (b+c). In accordance with a further aspect, the monofunctional polyalkylene glycol of formula (1) may have up to about 100, or up to about 80, in particular up to about 60, especially up to about 40 and particularly up to about 30 EO and AO units (b+c). In aspects where c is zero, the monofunctional polyalkylene glycol of formula (1) may have at least approximately 2, or at least approximately 4, in particular at least approximately 5, especially at least approximately 6, 7 or 8 and particularly preferably at least approximately 10 EO units, and in accordance with a further aspect the polyalkylene glycols of formula (1) may have up to about 100, or up to about 80, in particular up to about 60, especially up to about 40 and particularly preferably up to about 30 EO units. Thus, the degree off alkoxylation (b+c) may be in the range from about 2 to 100, or about 4 to 80, or about 5 to 60, or about 6, 7 or 8 to 40, or about 10 to 30.

In one aspect, the monofunctional polyalkylene glycols of formula (I) used in the reaction with the styrene maleic anhydride copolymer are those in which the value of b is greater than the value of c. These are monofunctional polyalkylene glycols which comprise more EO units than AO units. Thus in some aspects, the monofunctional polyalkylene glycol of formula (1) may have a ratio of EO to AO units of at least 2 to 1, or at least 3 to 1 or at least 5 to 1 or at least 10 to or at least 15 to 1 or at least 20 to 1 or even at least 30 to 1.

The reaction of the starter alcohol R¹—OH (or mixture of starter alcohols) with ethylene oxide and/or the alkylene oxide(s) is carried out by customary methods known to those skilled in the art, and in apparatuses conventionally used for this purpose.

The alkoxylation can be catalyzed by strong bases such as alkali metal hydroxides and alkaline-earth metal hydroxides, Brönsted acids or Lewis acids, such as AlCl₃, BF₃ and the like. Catalysts such as hydrotalcite or DMC may be used for alcohol alkoxylates with a narrow distribution.

The alkoxylation is preferably carried out at temperatures in the range of from approximately 80° C. to 250° C., or approximately 100° C. to 220° C. The pressure is preferably between ambient pressure and 600 bar. If desired, ethylene oxide and/or alkylene oxide may comprise an admixture of inert gas, for example of approximately 5 to 60%.

In formula (I), the ethylene oxide and alkylene oxide units can be arranged as desired. The structural unit [(EO)_{b}-(AO)_{c}] can thus be a homopolymer, random copolymer, a gradient copolymer, an alternating copolymer or a block copolymer made up of ethylene oxide and/or alkylene oxide units. In one particular aspect, the block copolymer made up of ethylene oxide and alkylene oxide units comprises a terminal ethylene oxide unit. In accordance with one aspect, it is preferred that the monofunctional polyalkylene glycol of formula (1) is ethoxylated, or have at least one ethylene oxide block. In a further aspect, the monofunctional polyalkylene glycol of formula (1) is propoxylated, or has at least one propylene oxide block. In yet a further aspect, the monofunctional polyalkylene glycol of formula (1) is ethoxylated and propoxylated and comprises a terminal ethylene oxide unit.

In one aspect, the theoretical molecular weight of the monofunctional polyalkylene glycol of formula (1) may be 5000 g/mol or less, or less 4000 g/mol or less, or 3000 g/mol or less, or even 2500 g/mol or less. In accordance with a particular aspect, the theoretical molecular weight of the monofunctional polyalkylene glycol of formula (1) is within the range of about 750 g/mol to about 5000 g/mol.

The reaction between the styrene maleic anhydride copolymer and the monofunctional polyalkylene glycol of formula (1) may be conducted in the presence of a base. In one aspect, the base may be a sodium hydroxide, potassium hydroxide, calcium hydroxide, lithium hydroxide, silver hydroxide, zinc hydroxide, ammonium hydroxide, magnesium hydroxide, barium hydroxide, strontium hydroxide, cesium hydroxide, rubidium hydroxide, ammonium carbonate, sodium carbonate, sodium bicarbonate, potassium carbonate, potassium bicarbonate, silver carbonate, lithium carbonate, lithium bicarbonate, barium bicarbonate, magnesium carbonate, cesium carbonate, hydrates thereof, and a trialkylamine, for example, triethylamine and tributylamine.

The reaction between the styrene maleic anhydride copolymer and monofunctional polyalkylene glycol of formula (I) may be also conducted in the presence of a solvent. Solvents which may be used are nonreactive toward the copolymer resin and the monofunctional polyalkylene glycol. In some aspects, the solvent is aprotic. For example, the solvent can be an aromatic solvent such as benzene and an alkylbenzene such as toluene and xylene, an ether such as methyl t-butyl ether, a ketone such as methylisobutylketone, an ester such as ethyl acetate, propyl acetate, a carbonate such as ethylene carbonate, propylene carbonate, and butylene carbonate, a halogenated aliphatic hydrocarbon such as dichloromethane, lactones such as butyrolactone, and an aliphatic nitrite such as butyronitrile. Mixtures of solvents may also be used. There may also be used co-solvents to change the properties of solvents or solvent mixtures. The solvent may be used in quantities sufficient to dissolve the copolymer resin and, optionally, the reaction product of this disclosure. The amount of solvent used can vary widely and will be any amount suitable for making the reaction product, as is apparent to one of skill in the art.

In one aspect, dispersants obtained from the reaction of the styrene maleic anhydride copolymer and the monofunctional polyalkylene glycol of formula (1) where b is greater than zero and c is zero may have a general structure according to formula (3):

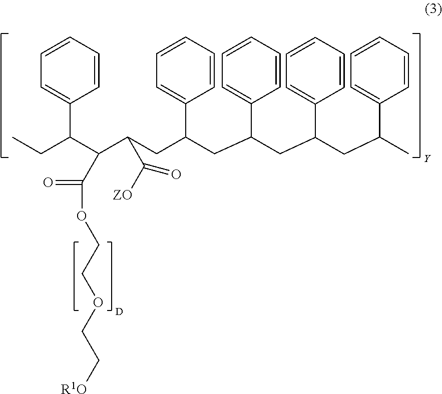

where R¹ is defined as above, Z is hydrogen, a monovalent metal ion or amine, and Y and D are variables depending on the selected reactants.

In some aspects, the dispersant comprises the reaction product in anionic form which may optionally be converted to an acid form by the addition of an acid known to those skilled in the art. However, it has been found the anionic form of the reaction product works surprisingly well and the additional step of converting it to its acid form may not be necessary. Thus, according to one particular aspect, the dispersant consists essentially of the reaction product in its anionic form. In still other aspects, the dispersant consists essentially of the reaction product in its acid form.

The dispersant may be made by dissolving the styrene maleic anhydride copolymer in a non-reactive solvent, such as propylene carbonate, and reacting the mixture with the desired monofunctional polyalkylene glycol of formula (1) optionally in the presence of a base at a temperature within a range of about 35° C. to about 150° C. The resin and solvent may be heated to about 60° C. prior to the addition of the monofunctional polyalkylene glycol of formula (1) to thereby facilitate a more rapid reaction. The order of addition is not believed to be critical and as such the anhydride resin can be added to the monofunctional polyalkylene glycol. In some aspects, the ratio of the amount of the monofunctional polyalkylene glycol relative to the amount of styrene maleic anhydride copolymer in the reaction mixture is greater than 1:1, such as greater than 1.25:1 or even greater than 1.5:1. However, it is believed that more or less than the stoichiometric amounts above can also form an excellent dispersant. The non-reactive solvent will act as a processing aid to simplify the synthesis of the dispersant product. The base can act as a catalyst to increase the reaction rate. In some aspects, the solvent may be left in the dispersant product while in other aspects the solvent may be removed from the dispersant product. As much or as little solvent can be used/removed as desired. Finally, the reaction product can be isolated and purified, as desired, using techniques well known to those of skill in the art.

In some aspects, the dispersant of the present disclosure will have a maximum viscosity of 800 mPa s at 25° C. In other aspects, the dispersant of the present disclosure may have a total solids content (%) of less than about 60, or less than about 55, or even less than about 50. In still other aspects, the dispersant of the present disclosure may have a total solids content (%) of more than about 35, or more than about 40, or even more than about 45.

The dispersants of the present disclosure offer advantages over state of the art dispersants prepared from styrene maleic anhydride copolymers which have a styrene to maleic anhydride molar ratio outside of the inventive molar ratio since agricultural compositions containing the inventive dispersants will exhibit a lower viscosity and improved performance at elevated temperature. The dispersants of the present disclosure can also reduce or prevent Ostwald ripening and allow for the high-shear milling of agrochemical suspension concentrate compositions as well as improving their suspensibility when diluted in water prior to application to a substrate. Finally, the inventive dispersants may generate less foam when mixed with water as compared to state of the art dispersants.

According to another aspect, there is provided an aqueous agricultural composition comprising the dispersant of the present disclosure and a pesticide.

In some embodiments, the pesticide is sparingly water-soluble. It is, in these embodiments, soluble in water at 20° C. to at most 10 g/L, preferably to at most 3 g/I, and in particular to at most 0.5 g/I. The pesticide is usually solid at 20° C. In some embodiments, the pesticide has a melting point of at least 50° C., or at least 80° C. and in particular at least 120° C.

According to one embodiment, the aqueous agricultural composition contains at least about 0.1% by weight of the dispersant, or at least about 0.5% by weight of the dispersant, or at least about 1% by weight of the dispersant, or at least about 3% by weight of the dispersant, or even at least about 5% by weight of the dispersant, based on the total weight of the aqueous agricultural composition.

In another embodiment, the aqueous agricultural composition contains less than about 7% by weight of the dispersant, or less than about 6% by weight of the dispersant, or less than about 5% by weight of the dispersant, or less than about 4% by weight of the dispersant, or even less than about 3% by weight of the dispersant, based on the total weight of the aqueous agricultural composition.

In yet another embodiment, the aqueous agricultural composition contains from about 0.05%-7% by weight of the dispersant, or from about 0.5%-6% by weight of the dispersant, or from about 1%-5.5% by weight of the dispersant, or even from about 3%-5% by weight of the dispersant, based on the total weight of the aqueous agricultural composition.

The aqueous agricultural composition may also comprise at least about 0.5% by weight of the pesticide. In some embodiments, it comprises at least about 2% by weight, or even at least about 5% by weight, of the pesticide, based on the total weight of the aqueous agricultural composition.

In other embodiments, the aqueous agricultural composition may comprise up to about 70% by weight, or up to about 65% by weight, or up to about 60% by weight, or up to about 50% by weight, or even up to about 40% by weight of the pesticide, based on the total weight of the aqueous agricultural composition. In case the aqueous agricultural composition contains a further pesticide, then the aforementioned amounts apply to the total amount of pesticide and further pesticide.

At least one pesticide is present in suspended form in the aqueous agricultural composition. A further pesticide may be present in suspended, emulsified or dissolved form, wherein the emulsified form is preferred. The further pesticide may be selected from the group of fungicides, insecticides, nematicides, herbicides, safeners, plant growth regulators and mixtures thereof. Thus, in another aspect, there is provided an agrochemical suspension concentrate composition comprising: a) a continuous aqueous phase; b) a partially water-soluble pesticide; and c) the dispersant of the present disclosure.

The aqueous agricultural composition can further comprise at least about 10% by weight of water, or at least about 30% by weight, and in particular at least about 45% by weight, of water, based on the total weight of the aqueous agricultural composition. In another embodiment, the aqueous agricultural composition may comprise up to about 90% by weight of water, or even up to about 75% by weight of water, based on the total weight of the aqueous agricultural composition.

The aqueous agricultural composition may also comprise agrochemical formulation auxiliaries. Suitable formulation auxiliaries are dispersants other than those of the present disclosure, solvents, liquid carriers, solid carriers or fillers, surfactants, emulsifiers, wetting agents, solubility promoters, penetration promoters, protective colloids, stickers, thickeners, humectants, repellants, attractants, feed stimulants, compatibilizing agents, bactericides, antifreezes, foam inhibitors, colorants, adhesives and binders.

The aqueous agrochemical compositions may be useful for the control of phytopathogenic fungi and/or undesired plant growth and/or undesired insect or mite attack and/or for regulating the growth of plants, where the composition is allowed to act on the particular pests, their habitat or the plants to be protected from the respective pest, the soil and/or on undesired plants and/or the useful plants and/or their habitat. Furthermore, use of the aqueous agrochemical compositions may control undesired insect or mite attack on plants and/or control phytopathogenic fungi and/or control undesired plant growth, in which case seed materials of useful plants are treated with the composition. Finally, the aqueous agrochemical compositions and suspension concentrate compositions may exhibit reduced Ostwald ripening. Thus, in another particular aspect, there is provided a suspension concentrate composition comprising: a) a continuous aqueous phase; b) a partially water-soluble pesticide; and c) the dispersant of the present disclosure, the dispersant being present in an amount sufficient to reduce or prevent Ostwald ripening of the pesticide (b) in the composition, such as in an amount of at least about 1% by weight of the dispersant, or at least about 3% by weight of the dispersant, or even at least about 5% by weight of the dispersant, based on the total weight of the suspension concentrate composition.

According to another aspect, the aqueous agrochemical compositions of the present disclosure may be used in conventional agricultural methods. For example, the aqueous agricultural composition may be applied post-emergence to a desired target substrate by any means, such as airplane spray tanks, knapsack spray tanks, cattle dipping vats, farm equipment used in ground spraying (for e.g., boom sprayers, hand sprayers), and the like.

In accordance with another embodiment, the presently described technology provides a method for killing or inhibiting or repelling a pest comprising the steps of providing a pesticide in a pesticidally effective amount, providing an effective amount of the dispersant of the present disclosure, combining the pesticide and optionally a fertilizer with the dispersant and water to prepare an aqueous agrochemical formulation, and contacting the aqueous agrochemical formulation and the pest.

In another aspect, there is provided a method for reducing or preventing Ostwald Ripening of an aqueous agricultural composition comprising adding the dispersant above to the aqueous agricultural composition. In one particular aspect, the aqueous agricultural composition comprises a pesticidally effective amount of a pesticide.

The dispersant may also be used in other applications including as a pigment dispersant for paint, dye or ink formulations and as a superplasticizer for cement or wallboard. Thus, other aspects of the present disclosure include a paint composition comprising the dispersant, a dye or ink formulation comprising the dispersant, and a cement or wallboard comprising the dispersant.

### EXAMPLES

### Example 1: Dispersant Synthesis Procedure

The following procedure was used to prepare the dispersants used in the examples below.

In a suitable reaction vessel equipped with electrical heating, overhead stirring, and an inert atmosphere, were combined a styrene maleic anhydride copolymer resin (in powder form), tetrohydrofuran (THF), a monofunctional polyalkylene glycol of formula (1) and a base according to the amounts shown below in Table 1. The mixture was heated to 60° C. and stirred vigorously for 12-16 hours, during which the resin dissolved and reacted with the glycol. After the reaction was complete, a glycol ether solvent was added. The base was selectively removed by centrifugation and the THF was selectively removed under vacuum at 70° C., leaving a clear solution of dispersant in glycol ether. The dispersant concentration, based on solids, was 50%.

TABLE 1

| | | | Part 2 | | | | |
|---|---|---|---|---|---|---|---|
| | Part 1 | Grams | Polyalkylene | Grams | Grams | Grams | Grams |
| | SMA resin | Resin | Glycol | Glycol | THF | Base | DPM |
| Dispersant 1 | XIRAN-EF40 | 30.4 | MPEG 1200 | 69.6 | 100 | 9¹ | 100 |
| Dispersant 2 | XIRAN-EF60 | 37.5 | MPEG 1200 | 62.5 | 100 | 9¹ | 100 |
| Dispersant 3 | XIRAN-EF80 | 43.9 | MPEG 1200 | 56.1 | 100 | 9¹ | 100 |
| Dispersant 4 | XIRAN-EF40 | 41 | MPEG 750 | 59 | 100 | 9¹ | 100 |
| Dispersant 5 | XIRAN-EF80 | 15.8 | MPEG 5000 | 84.2 | 100 | 9¹ | 100 |
| Dispersant 6 | XIRAN-EF40 | 20.7 | MPEG 2000 | 79.3 | 100 | 9¹ | 100 |
| Dispersant 7 | XIRAN-EF80 | 31.9 | MPEG 2000 | 68.1 | 100 | 9¹ | 100 |
| Dispersant 8 | XIRAN-EF60 | 32.4 | Phenyl PEG 1500 | 67.6 | 100 | 9¹ | 100 |
| Dispersant 9 | XIRAN-EF80 | 38.4 | Phenyl PEG 1500 | 61.6 | 100 | 9¹ | 100 |
| Dispersant 10 | XIRAN-EF80 | 37.5 | Me EO/PO 1200 | 62.5 | 100 | 9¹ | 100 |
| Dispersant 11 | XIRAN-EF60 | 37.5 | MPEG 1200 | 62.5 | 100 | 18² | 100 |

Styrene maleic anhydride resins were obtained from Polyscope Polymers:
XIRAN® EF-40 resin has a styrene:maleic ratio of 4:1
XIRAN® EF-60 resin has a styrene:maleic ratio of 6:1
XIRAN® EF-80 resin has a styrene:maleic ratio of 8:1
   MPEG polyalkylene glycols were obtained from Huntsman Petrochemical LLC:
Phenyl PEG 1500 has a general structure according to:

Ph-O[EO]_{b}—O—C₂H₄—OH

where b is about 31
Me EO/PO 1200 has a general structure according to:

CH₃—O—[(EO)_{b}—(PO)_{c}-(EO)_{b1}]—C₂H₄—OH
where b is about 12, c is about 3 and b1 is about 11.
   Base¹ and Base² were respectively K₂CO₃ and Cs₂CO₃.
   THF and glycol ether solvent were tetrahydrofuran and dipropylene glycol methyl ether (DPM), respectively.

### Example: Use of Dispersants in Formulations

Fungicide SC: In a 400 ml mixing vessel were combined: water (118.3 g), propylene glycol (19.2 g), SURFONIC® L24-7 surfactant (a wetting agent) (4.8 g), Dispersant 2 (7.5 g), fludioxonil fungicide (technical active ingredient) (150 g), and SAG 1572 antifoam (Momentive) (0.3 g). This slurry was transferred to a high-shear bead mill (Eiger Mini-100, EMI Engineered Mills, Grayslake, Ill.), and milled at 2500 rpm for 6 minutes using 1 mm zirconox media. The product was a smooth, thin, white suspension with a median particle size of 3.06 microns.

Fungicide SC: In a 400 ml mixing vessel were combined: water (118.3 g), propylene glycol (19.2 g), SURFONIC® L24-7 surfactant (a wetting agent) (4.8 g), Dispersant 1 (7.5 g), fluoxastrobin fungicide (technical active ingredient) (150 g), and SAG 1572 antifoam (Momentive) (0.3 g). This slurry was transferred to a high-shear bead mill (Eiger Mini-100, EMI Engineered Mills, Grayslake, Ill.), and milled at 2500 rpm for 6 minutes using 1 mm zirconox media. The product was a smooth, thin, white suspension with a median particle size of 2.6 microns.

Herbicide SC: In a 400 ml mixing vessel were combined: water (118.3 g), propylene glycol (19.2 g), SURFONIC® L24-7 surfactant (a wetting agent) (4.8 g), Dispersant 3 (7.5 g), metribuzin herbicide (technical active ingredient) (150 g), and SAG 1572 antifoam (Momentive) (0.3 g). This slurry was transferred to a high-shear bead mill (Eiger Mini-100, EMI Engineered Mills, Grayslake, Ill.), and milled at 2500 rpm for 6 minutes using 1 mm zirconox media. The product was a smooth, thin, white suspension with a median particle size of 3.78 microns.

Herbicide SC: In a 400 ml mixing vessel were combined: water (118.3 g), propylene glycol (19.2 g), SURFONIC® L24-7 surfactant (a wetting agent) (4.8 g), Dispersant 11 (7.5 g), metribuzin herbicide (technical active ingredient) (150 g), and SAG 1572 antifoam (Momentive) (0.3 g). This slurry was transferred to a high-shear bead mill (Eiger Mini-100, EMI Engineered Mills, Grayslake, Ill.), and milled at 2500 rpm for 6 minutes using 1 mm zirconox media. The product was a smooth, thin, white suspension with a median particle size of 4.28 microns.

Insecticide SC: In a 400 ml mixing vessel were combined: water (118.3 g), propylene glycol (19.2 g), SURFONIC® L24-7 surfactant (a wetting agent) (4.8 g), Dispersant 2 (7.5 g), clothianidin (technical active ingredient) (150 g), and SAG 1572 antifoam (Momentive) (0.3 g). This slurry was transferred to a high-shear bead mill (Eiger Mini-100, EMI Engineered Mills, Grayslake, Ill.), and milled at 2500 rpm for 6 minutes using 1 mm zirconox media. The product was a smooth, pourable, white suspension with a median particle size of 3.00 microns

While the foregoing is directed to embodiments of the present disclosure, other and further embodiments of the disclosure may be devised without departing from the basic scope thereof, and the scope thereof is determined by the claims that follow.

1. A dispersant obtained from the reaction of a styrene maleic anhydride copolymer having a styrene to maleic anhydride molar ratio of at least 4.0:1.0 and a monofunctional polyalkylene glycol of the formula (1):
R¹O—(CₚH₂ₚO)_{z}—[(EO)_{b}-(AO)_{c}]—H (1)
where R¹ is an alkyl group or aromatic group; p is 2 or 3; z is 0, 1, 2, or 3; EO is ethyleneoxy; AO is alkyleneoxy; b is an integer in the range from 0 to 100; c is an integer in the range from 0 to 100; and where at least one of b or c is greater than zero.

2. The dispersant according to claim 1, wherein z is zero and b is greater than zero.

3. The dispersant according to claim 2, wherein the styrene maleic anhydride copolymer has a styrene to maleic anhydride molar ratio of at least 5.0.1.0.

4. The dispersant according to claim 3, wherein the styrene maleic anhydride copolymer has a styrene to maleic anhydride molar ratio of at least 6.0:1.0.

5. The dispersant according to claim 1, wherein R¹ is a lower alkyl group.

6. The dispersant according to claim 1, wherein R¹ is a phenyl group.

7. The dispersant according to claim 1, wherein z is zero, b is greater than zero, c is greater than zero and AO is propyleneoxy.

8. The dispersant according to claim 7, wherein the group [(EO)_{b}-(AO)_{c}] comprises a terminal ethyleneoxy group.

9. A process for forming a dispersant comprising dissolving a styrene maleic anhydride copolymer having a styrene to maleic anhydride molar ratio of at least 4.0:1.0 in a non-reactive solvent and reacting the mixture with a monofunctional polyalkylene glycol of the formula (1):
R¹O—(CₚH₂ₚO)_{z}—[(EO)_{b}-(AO)_{c}]—H (1)
where R¹ is an alkyl group or aromatic group; p is 2 or 3; z is 0, 1, 2, or 3; EO is ethyleneoxy; AO is alkyleneoxy; b is an integer in the range from 0 to 100; c is an integer in the range from 0 to 100; and where at least one of b or c is greater than zero.

10. The process according to claim 9, wherein b is greater than zero.

11. The process according to claim 9, wherein the reaction occurs in the presence of a base.

12. The process according to claim 11, wherein the base is a carbonate base.

13. An aqueous agricultural composition comprising the dispersant of claim 1 and a pesticide.

14. The aqueous agricultural composition of claim 13, wherein the dispersant is present in an amount from about 1%-5.5% by weight, based on the total weight of the aqueous agricultural composition.

15. The aqueous agricultural composition of claim 13, wherein the pesticide is present in an amount of up to about 70% by weight, based on the total weight of the aqueous agricultural composition.

16.-18. (canceled)
